(19) United States
(12) Patent Application Publication
(10) Pub. No.: US 2024/0157303 A1
(43) Pub. Date: May 16, 2024

(54) DIALYZER

(71) Applicant: FRESENIUS MEDICAL CARE DEUTSCHLAND GMBH, Bad Homburg (DE)

(72) Inventors: Paul GASTAUER, Bad Homburg (DE); Franz KUGELMANN, Bad Homburg (DE); Michael PAUL, Bad Homburg (DE); Andreas RUFFING, Bad Homburg (DE); Tobias VEIT, Bad Homburg (DE)

(73) Assignee: FRESENIUS MEDICAL CARE DEUTSCHLAND GMBH, Bad Homburg (DE)

(21) Appl. No.: 18/284,542

(22) PCT Filed: Apr. 6, 2022
(86) PCT No.: PCT/EP2022/059075

§ 371 Date: Sep. 28, 2023

(30) Foreign Application Priority Data
Apr. 9, 2021 (DE) 10 2021 108 842.9

(51) Int. Cl. B01D 63/02; B01D 61/24; B01D 61/28; B01D 71/06

(52) U.S. Cl. CPC B01D 63/021; B01D 61/243; B01D 61/28; B01D 71/06; B01D 2313/04; B01D 2313/205; B01D 2313/2061; B01D 2313/21

(57) ABSTRACT

The invention relates to a filter device for the exchange of substances, comprising a pipe section-shaped housing with a center of gravity and with two housing ends, in which housing a hollow fiber bundle consisting of semi-permeable membranes is arranged, comprising, furthermore, an end cap having a first and second opening, wherein the housing and the end cap configure a first sealing surface which connects the housing and the end cap sealingly, and wherein the first sealing surface is spaced apart further from the center of gravity of the housing than the aperture, and wherein a first fluid chamber is formed between the first sealing surface and the first opening of the end cap, via which first fluid chamber the first opening is connected to the first flow chamber, wherein the housing and the one end cap configure a second sealing surface, wherein the first and second sealing surface are not configured by way of a sealant.

### TECHNICAL FIELD

The invention relates to a filter device for material exchange, more particularly for haemodialysis, comprising a pipe section-shaped housing having a centre of gravity and having two housing ends, in which housing there is arranged a hollow-fibre bundle composed of semi-permeable membranes, the fibre cavities of which hollow-fibre bundle form a first flow space, and the housing interior surrounding the hollow-fibre bundle forms a second flow space, wherein the flow spaces are separated from one another at the housing ends by at least one flow-space seal, wherein the housing is provided with at least one breach at least one end and the at least one breach is arranged closer to the centre of gravity of the housing than the flow-space seal, comprising furthermore at least one end cap having a first and a second opening. The invention further relates to a method for producing such a filter device.

### BACKGROUND OF THE INVENTION

Filter devices for material exchange, more particularly for haemodialysis, are known in the prior art. In filtration technology and more particularly in haemodialysis, the use of semi-permeable hollow-fibre membranes as separation medium has been found to be advantageous, since they are simple to produce and exhibit outstanding separation characteristics. In haemodialysis, the use of polysulfone-based materials in conjunction with an addition of polyvinylpyrrolidone for hollow-fibre membranes has proven to be market-dominant. Such a membrane is described in EP0168783A1. These membranes are collected to form hollow-fibre bundles and fitted into a filter housing. Thereafter, sealing of two flow spaces has to be carried out. In the case of haemodialysis, sealing takes place between the blood side and the dialysate side of the haemodialyser. Accordingly, fluid inlets and outlets must be created in order to be able to provide the filter with the respective raw fluids and to remove the processed fluids. In the case of haemodialysis, the two fluids, separated by the semi-permeable membrane or the hollow-fibre membrane bundle, are guided past one another in counterflow, and so altogether 4 fluid inlets per dialyser are required. In the case of dead-end filtration, two fluid inlets may be sufficient.

Such a filter housing for dialysis is described in EP2326410A1. Here, the respective dialysate inlets and outlets are provided on the pipe section-shaped housing and the respective blood inlets are arranged in separate components, the end caps. The end caps are then sealed from the filter housing, with a separate elastomeric seal being provided. All the components are produced from thermoplastics in an injection moulding method.

A simplified construction is described in DE10147907, wherein one fluid inlet and one fluid outlet are provided per end cap in such an arrangement. Such an arrangement exhibits a substantial simplification with respect to production, since the respective production moulds for the pipe section-shaped housing are simplified. With these very large production moulds, it is therefore possible to dispense with complicated additions, such as sliders for example, at least in part. Said additions can be accommodated more easily in a smaller end-cap mould. Therefore, it is additionally possible to avoid the use of excessively large injection-moulding machines. Also in DE10147907, the respective fluid spaces are connected to one another via sealing elastomeric components at least in part.

However, the use of sealing elastomeric components disadvantageously leads to the formation of dead volumes, and this impedes the efficiency of material exchange. Dead volumes are disadvantageous especially in the blood compartment, since blood which is flowing extracorporeally with an excessively low flow rate or not at all has a tendency towards coagulation of thrombocytes and can therefore cause clogging of a dialyser.

Furthermore, it is disadvantageous to have to use additional components. Moreover, elastomeric components are frequently disadvantageous because the materials can exhibit low blood-compatibility. If said elastomeric components are, for example, made of EPDM, plasticizers can escape into the blood. The same generally applies to filtration technology, since the transfer of substances into the filtrate is disadvantageous in the case of these applications as well.

Besides the use of elastomeric components as sealant, it is also possible to use adhesives. Such use of adhesives is very complicated with respect to production and is also very time-consuming depending on the reaction kinetics of the adhesive. Moreover, disadvantageous constituents of the adhesive can pass into the filtrate or the blood.

### OBJECT OF THE INVENTION

It is therefore an object of the invention to provide a filter device for material exchange, more particularly for haemodialysis, that prevents or at least lessens the disadvantages of the prior art. In particular, it is an object of the invention to provide a particularly simple-to-produce filter device for material exchange, more particularly for dialysis, that at the same time reduces the disadvantageous effects on a filtrate. In the case of a dialyser, a disadvantageous effect on the blood to be purified is to be reduced.

### SUMMARY OF THE INVENTION

According to the invention, the object is achieved according to a first aspect of the invention by a filter device for material exchange, more particularly for haemodialysis, comprising a pipe section-shaped housing having a centre of gravity and having two housing ends, in which housing there is arranged a hollow-fibre bundle composed of semi-permeable membranes, the fibre cavities of which hollow-fibre bundle form a first flow space, and the housing interior surrounding the hollow-fibre bundle forms a second flow space, wherein the flow spaces are separated from one another at the housing ends by at least one flow-space seal, wherein the housing is provided with at least one breach at least one end and the at least one breach is arranged closer to the centre of gravity of the housing than the flow-space seal, comprising furthermore at least one end cap having a first and a second opening, wherein the housing and the at least one end cap form a first sealing area which connects the housing and the end cap in a sealing manner and wherein the first sealing area is at a further distance from the centre of gravity of the housing than the at least one breach, and wherein a first fluid space is formed between the first sealing area and the first opening of the end cap, via which first fluid space the first opening is fluidically connected to the first flow space, wherein the housing and the at least one end cap form a second sealing area which connects the housing and the end cap in a sealing manner and the second sealing area is arranged closer to the centre of gravity of the housing than the flow-space seal and the at least one breach, and wherein a second fluid space is formed between the first and second sealing area and the second opening of the end cap, via which second fluid space the second opening of the end cap is fluidically connected to the second flow space through the at least one breach, wherein the first and second sealing area are not formed by a sealant.

What is therefore proposed is a particularly simple-to-produce filter device which copes without the use of sealants such as elastomeric components or adhesives. This prevents or reduces dead volumes. If the filter device is operated in haemodialysis, disadvantageous effects on the blood are reduced. A tendency towards clogging due to aggregation of thrombocytes is reduced in particular.

According to one development of the invention, what is proposed is a filter device, characterized in that, in both the first and the second sealing area, molecules of the housing are entangled with molecules of the end cap. The entanglement of the molecules ensures a particularly secure and long-term stable connection of the end cap to the housing. Entanglement of the molecules of the housing with the molecules of the end cap in the first and second sealing area is achieved by ensuring melting of the respective surfaces during the connection of the housing to the end cap. The melted surfaces are then contacted with one another, thereby ensuring the entanglement of the molecules.

It has been found to be particularly advantageous when the melting points or glass transition points of the materials of the housing and the end cap differ by less than 10° C., preferably less than 5° C., particularly preferably less than 3° C. Particularly secure connections are then possible, which at the same time minimize disadvantageous effects on filtrate and blood.

In one embodiment, what can be provided is that the first sealing area is at a further distance from the centre of gravity of the housing than the at least one breach and the flow-space seal. Such an arrangement is even more compact and has in particular reduced dead volumes.

Furthermore, in a particular embodiment, what can be provided is that the pipe section-shaped housing and the end cap are formed from the same group of materials. If both components are made from one group of materials, the process of sealing is substantially facilitated. The entanglement of the molecules of end cap and housing is facilitated in particular if one group of materials is used for both components. “Group of materials” means, for example, identical materials, but in different colouring. Different copolymer compositions can also be subsumed under one group of materials.

According to one development of the invention, the material of the housing and the end cap comprises polypropylene or copolymers of polypropylene or polycarbonate, more particularly polypropylene or copolymers of polypropylene. Both materials exhibit sufficiently high transparency and are suitable as thermoplastic materials for ensuring entanglement of the molecules of the housing with the molecules of the end cap. Polypropylene in particular is particularly highly suited, since it is a particularly light material and is at the same time producible with particularly low wall thicknesses of less than 2 mm in the case of the housing. Accordingly, one embodiment of the invention is characterized in that the wall thickness of the housing is less than 2 mm. In a further embodiment, the wall thickness of the end cap is also less than 2 mm, more particularly less than 1.5 mm. Therefore, in a particular embodiment, what can be provided is that the wall thickness of the end cap is lower than the wall thickness of the housing, preference being given in this case to using a polypropylene-based material for both components.

According to a further particular embodiment, the first sealing area is equal to or larger than, more particularly larger than, the cross-sectional area of the pipe section-shaped housing at the housing end. If the sealing area is equal to the cross-sectional area of the pipe section-shaped housing at the housing end, a particularly good sealing effect is ensured through optimal utilization of the possible sealing area. In a preferred embodiment, what can also be provided is that the sealing area is larger than the cross-sectional area of the pipe section-shaped housing at the housing end. This can be ensured by configuring the melting process such that a relatively large amount of material is melted and squashing is carried out in the subsequent joining process. Such a component has a bead-shaped sealing area, and this has an advantageous effect on the sealing effect. The bead can also advantageously lead to a possible dead volume being further reduced, and this is particularly desirable especially in the case of haemodialysis.

Furthermore, in a preferred embodiment of the filter device, there are two end caps at the opposite ends of the pipe section-shaped housing and the housing is provided with breaches and flow-space seals at both ends and the breaches are in each case arranged closer to the centre of gravity of the housing than the flow-space seals. The use of two filter caps at the two ends is particularly advantageous for haemodialysis, since the blood and the dialysate can thereby be guided in counterflow. This leads to particularly efficient blood purification.

Furthermore, what can be provided is that the housing has a multiplicity of breaches at at least one end. In the case of haemodialysis, the result of this is that a particularly uniform dialysate flow rate is made possible. The separation efficiency for uraemia toxins is therefore further improved. At the same time, the hydraulic pressure in the dialysate and thus the mechanical load on the sealing areas is reduced. Thus, a relatively high dialysate flow rate can also be achieved, and this in turn has a favourable effect on the separation efficiency of the filter device. What can also be provided is that the housing has a multiplicity of breaches at both ends.

A particular embodiment is characterized in that the filter device is a dialyser and in that the first openings of the end caps allow an inflow of blood and an outflow of blood and in that the second openings of the end caps allow an inflow of dialysate and an outflow of dialysate.

In a further development of the invention, the pipe section-shaped housing does not comprise a dialysate inlet or dialysate outlet. Such a housing is particularly inexpensive and obtainable through a simplified mold. In addition, it enables to more easily provide a multi-cavity mold for the housing, leading to cost and energy savings.

In a preferred embodiment, the material of the flow-space seal comprises epoxy resin or polyurethane resin as sealing material. Particular preference is given to polyurethane because it allows particularly good sealing when using hollow fibres having an outer diameter of less than 300 μm. In the case of hollow-fibre bundle packing densities of over 60% as well, the material polyurethane is advantageous owing to its flow properties.

In a further embodiment, at least one energy director is arranged on the pipe-shaped housing section and/or on the end cap, respectively. Such an arrangement is preferred when the end cap and the housing are connected by ultrasonic joining. Such an energy director increases the sealing effect of joining considerably and quickens and simplifies the joining process.

Preferably, the material of the semi-permeable membrane comprises polysulfone, polyethersulfone, polyvinylpyrrolidone, polymethyl methacrylate, polyimide, polyester, cellulose or polyacrylonitrile. Particular preference is given to a material predominantly consisting of a mixture of polysulfone or polyethersulfone and polyvinylpyrrolidone. This means that the material consists of said mixture to an extent of more than 50% by weight. Said mixture is particularly blood-compatible and therefore further improves the properties of the filter device, more particularly the dialyser.

According to a second aspect of the invention, the object is achieved by a method for producing a filter device according to the first aspect of the invention, characterized in that the first and second sealing area are in each case produced by fusing and cooling of the regions of the housing and the end cap that face the sealing areas with formation of a sealing connection and in that entanglement of molecules of the housing with molecules of the end cap is carried out.

In one development of the method, the sealing areas are in each case produced by welding, more particularly by hot-surface welding, laser beam welding, spin welding or ultrasonic welding, more particularly by hot-surface welding. These methods ensure secure fusing and joining of the components. In particular, what is ensured is that the desired joining area, more particularly a bead-shaped, particularly well-sealing joining area, can be provided.

Preferably, it is provided to carry out the following process steps for the manufacture of a filter device, if a hot-surface welding or hot-plate welding process is carried out:
a) providing the end cap
b) providing the pipe-shaped housing section
c) providing the hot-plate welding tool between the end cap and the housing section, the hot-plate welding tool having, at least at the provided at least 4 contact surfaces, a temperature which is above the melting point or glass transition point of the respective joining material
d) bringing the hot-plate welding tool into contact with the contact surfaces of the end cap and the housing section to be welded
e) melting the contact surfaces
f) removing the hot-plate welding tool
g) welding the end cap and the housing section by pressing together the melted contact surfaces
h) cooling the melted contact surfaces below the melting point or glass transition point of the respective material.

According to a third aspect of the invention, a hot-plate welding tool suitable for carrying out a method according to the second aspect of the invention, or for use in a method according to the second aspect of the invention, is provided.

Such a hot-plate welding tool correspondingly comprises 4 contact surfaces, at which the simultaneous local contact and material melting of the end cap and the pipe-shaped housing section takes place during the method according to the second aspect of the invention.

In a preferred embodiment, the contact surface between the housing section to be melted and the hot-plate welding tool is configured such that the contact surfaces of the housing section or the end cap to the tool contact at surfaces, which in a longitudinal direction of the (imaginary) housing section are formed at angles of 0 to 90° difference. Angles between 20 and 70° are preferred, between 30 and 60° more preferred, and between 40 and 50° yet more preferred.

According to a further embodiment, these contact surfaces are concave.

### BRIEF DESCRIPTION OF THE DRAWINGS

Further details and advantages of the present invention will be more particularly elucidated on the basis of an exemplary embodiment depicted in the drawings. In the figures:

FIG. 1 shows a schematic depiction of a pipe section-shaped housing

FIG. 2 shows a schematic depiction of an end cap

FIG. 3 shows a schematic depiction of a filter device, comprising a pipe section-shaped housing and an end cap

FIG. 3a shows an enlarged depiction of FIG. 3 in the region of a first sealing area

FIG. 4 shows a schematic depiction of an arrangement of pipe-shaped housing, end cap and hot-plate welding tool during a heating phase of a hot-plate welding process

FIG. 5 shows a schematic depiction of a section of a heating element tool or hot-plate welding tool with the corresponding section of the housing, representative of a special embodiment

FIG. 5b shows a schematic depiction of a section of a heating element tool or hot-plate welding tool with the corresponding end cap section, representative of a specific embodiment

FIG. 6a shows a schematic depiction of a section of a heating element tool or hot-plate welding tool, representative of a specific embodiment

### DETAILED DESCRIPTION OF AN EXEMPLARY EMBODIMENT

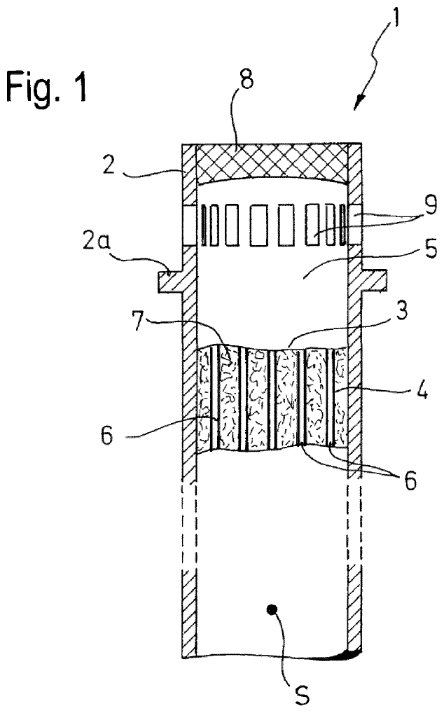

FIG. 1 shows a pipe section-shaped housing 2 of a filter device 1 that comprises a hollow-fibre bundle 3 composed of semi-permeable membranes 4. At the ends, the pipe section-shaped housing 2 comprises a flow-space seal 8, which is depicted here concavely toward the centre of gravity S. The flow-space seal 8 is made of polyurethane; an arrangement of epoxy resin or ceramic sealing material is similarly possible. If the filter device 1 is used for dialysis, polyurethane is preferred. The outer surface of the flow-space seal 8 is configured such that the hollow-fibre membranes 4 are open, and so a first flow space 6 is formed that comprises the interior of the hollow-fibre membranes 4. The second flow space 7 is situated in the housing 2 outside the hollow-fibre membranes 4. FIG. 1 shows furthermore breaches 9 in the housing 2, which are arranged closer to the centre of gravity S of the housing 2 than the flow-space seal 8. If the filter device 1 is a dialyser, dialysate can be supplied to the outer surface of the hollow-fibre membrane 4 or removed therefrom via said breaches 9, and so material exchange can take place between the blood side of the dialyser, represented by the first flow space 6, and the dialysate, represented by the second flow space 7. In another embodiment, it is also possible to guide the blood in the second flow space 7 and the dialysate in the first flow space 6. The housing 2 comprises furthermore a housing projection 2a, which is arranged closer to the centre of gravity S of the housing 2 than the flow-space seal 8 and the breaches 9.

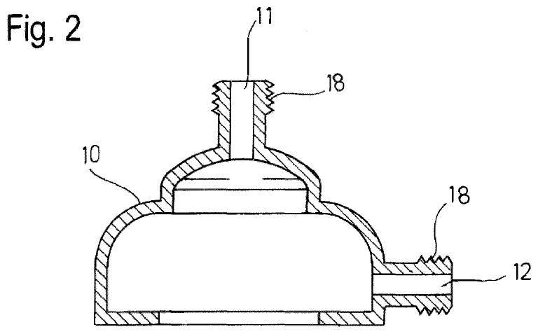

FIG. 2 shows an end cap 10 having a first opening 11 and a second opening 12. Provided on the outsides of said openings 11 and 12 are threads 18 or devices for connection of fluid lines, which are not shown here.

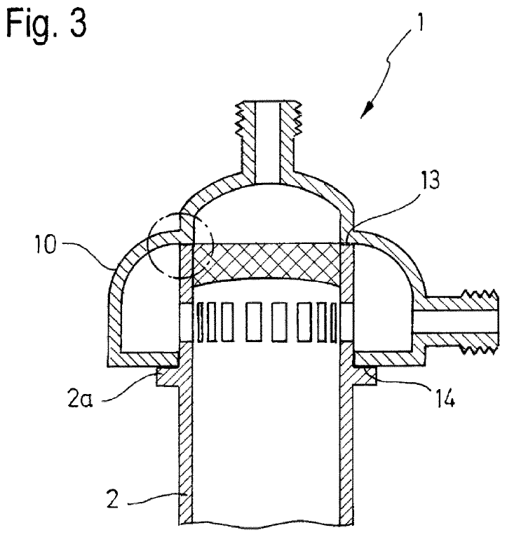

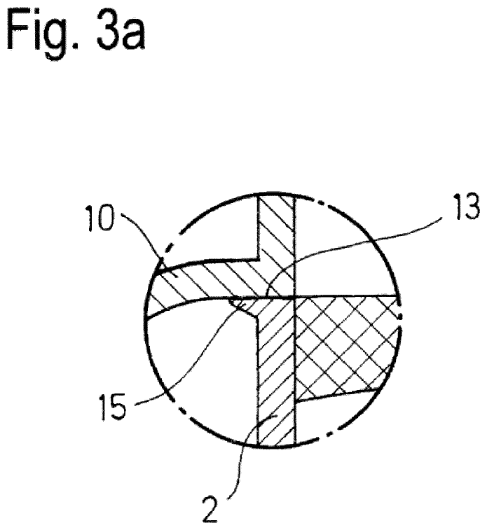

FIG. 3 shows the assembly of the end cap 10 with the pipe section-shape housing 2. The two components are designed such that a first 13 and a second 14 sealing area are present. Via the first opening 11, it is possible, then, for fluid to enter the first flow space 6 or to be removed from the opening 11; the first sealing area 13 prevents an undesired transfer of the fluid into the second flow space 7. Via the second opening 12, it is possible, then, for fluid to enter the second flow space 7 or to be removed from the second opening 12; the first 13 and the second 14 sealing area prevent an undesired transfer of the second fluid into the first flow space 6. Shown on the pipe-shaped housing 2 is the projection 2a, which, in this exemplary embodiment, forms the second sealing area 14 together with the end cap 10.

FIG. 3a shows an enlargement of the region of the first sealing area 13, and what is formed is a first sealing area 13 which is larger than the cross-sectional area of the pipe section-shaped housing 2 at the housing end. What is shaped is a bead 15. In this exemplary embodiment, it was produced by a hot-plate welding method, the joining partners having been joined with such a pressure that enlargement of the first sealing area 13 occurred.

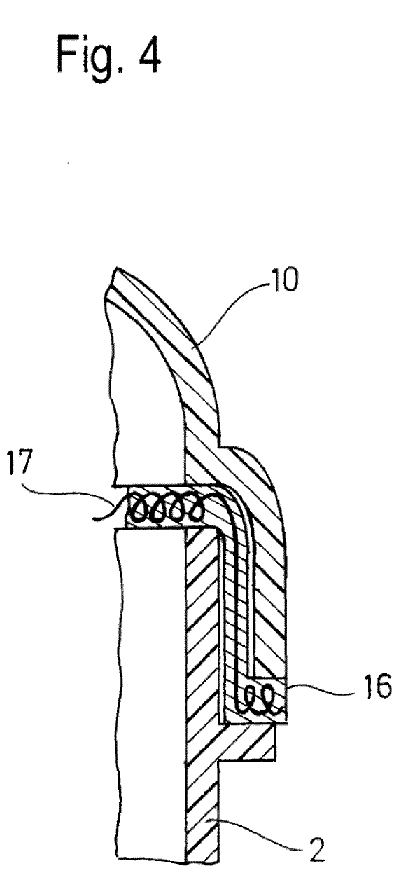

FIG. 4 shows schematically the joining process in the formation the filter device 1 by joining of the end cap 10 and the pipe-shaped housing section 2, the two joining partners being composed of polypropylene. Other materials are also possible, especially also polycarbonate. FIG. 4 shows the end cap 10, the pipe-shaped housing section 2 and a cross section of a hot-plate welding tool 16. The tool provides a contact area with those areas of the end cap 10 and the housing 2 that must be brought into contact for joining of the work pieces in order to form the first 13 and second 14 sealing area. In what is depicted, there is also depicted a tool heating element 17, which ensures heating of the contact areas of the joining partners above the melting point or the glass transition point of the material. After the heating process, the joining partners can be moved further apart, so that the hot-plate welding tool 16 can be removed. Then, the joining partners are joined such that the first 13 and second 14 sealing area are formed. In this exemplary embodiment, molecules of the end cap 10 are intimately entangled with molecules of the pipe-shaped housing section 2. This gives rise to first 13 and second 14 sealing areas which exhibit particularly high leak-tightness.

Alternatively, the first 13 and second 14 sealing areas can also be provided by spin welding or by laser beam welding. Spin welding is possible and preferred when the first 13 and second 14 sealing area are arranged with rotational symmetry. Ultrasonic welding is similarly possible, and in this case at least one energy director is to be preferably provided on the pipe-shaped housing section 2 and/or on the end cap 10, respectively.

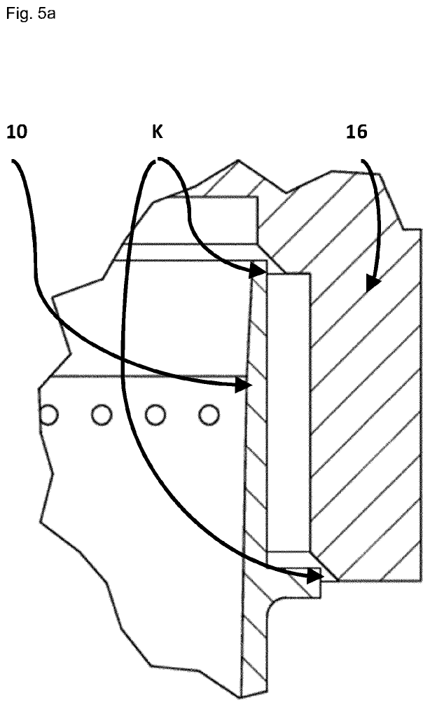

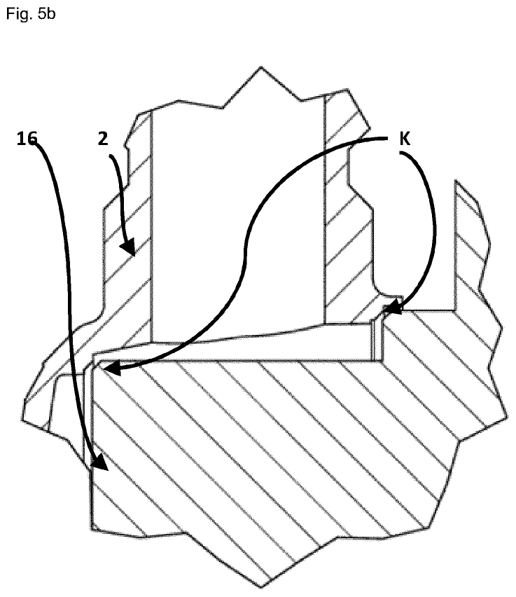

FIG. 5a represents a further preferred embodiment of the joining process in the formation the filter device 1 by joining of the end cap 10 and the pipe-shaped housing section 2, wherein the pipe-shaped housing section and the hot-plate welding tool 16 are represented in an enlarged partial view. In this embodiment, the contact surface between the housing section 2 to be melted and the hot-plate welding tool 16 is configured such that the contact surface of the housing section 2 contacts the tool at a surface, which in a longitudinal direction of the housing section is formed in an angle different from 0 and 90°. An angle of between 20 and 70° is preferred, between 30 and 60° more preferred, and between 40 and 50° yet more preferred. In the embodiment, the angle is 45°. Such embodiment has the advantage to enable a precise control of the joining position, resulting in a particularly secure and low-waste joining connection. In addition, a weld bead is particularly small in such embodiment, such that possible restrictions in the fluid flow path during the separation process are reduced. In the case of a dialyzer, this in particular pertains to the dialysate side.

FIG. 5b represents a further preferred embodiment of the joining process in the formation the filter device 1 by joining of the end cap 10 and the pipe-shaped housing section 2, wherein the end cap and the hot-plate welding tool 16 are represented in an enlarged partial view. In this embodiment, the contact surface between the section of the end cap 10 to be melted and the hot-plate welding tool 16 is configured such that the contact surface of the end cap 10 contacts the tool 16 at a surface, which in a longitudinal direction of the (imaginary) filter device touches at an angle different from 0 and 90°. An angle of between 20 and 70° is preferred, between 30 and 60° more preferred, and between 40 and 50° yet more preferred. In the embodiment, the angle is 45°. Such embodiment has the advantage to enable a precise control of the joining position, resulting in a particularly secure and low-waste joining connection. In addition, a weld bead is particularly small in such embodiment, such that possible restrictions in the fluid flow path during the separation process are reduced. In the case of a dialyzer, this in particular pertains to the blood side. The weld bead is thereby formed such that a dead volume in the blood room is as small as possible, or a dead volume is even avoided altogether. A dead volume at the blood side can lead to strong coagulation of blood, which results in successive clogging of the dialyzer.

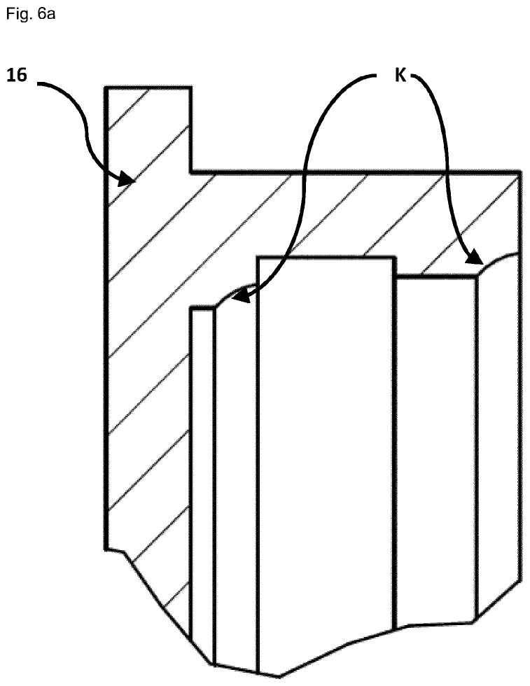

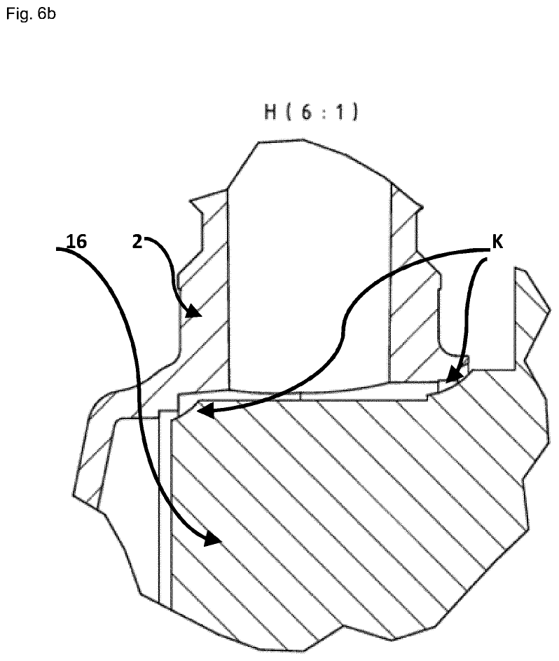

A further embodiment is shown in FIG. 6a, which constitutes a further improved modification of the embodiment of FIG. 5a. In this embodiment, the contact surface between the housing section 2 to be melted and the hot-plate welding tool 16 is configured such that the contact surface of the housing section 2 contacts the tool at a surface, which in a longitudinal direction of the housing section is formed in an angle different from 0 and 90°, wherein the surface has a concave curvature. A concave curvature is to be understood such that the curvature protrudes into the welding tool. The radius of the curvature has to be adjusted to the dimensions of the housing. In the case of a filter device having the size of a dialyzer, preferred curvature radii are between 1 mm and 10 mm, in particular between 2 and 8 mm, further in particular between 3 and 6 mm. In the embodiment, the radius is 4.5 mm. A concave curvature simplifies the precise reception of the joining partner even at higher tolerance of the joining partner, resulting in a further increased product safety and quality of the weld. High tolerance occurs in particular if polyolefin, more particularly propylene-based material is used as a housing material. FIG. 6b is applicable to the joining of the end cap 2 accordingly.

### LIST OF REFERENCE SIGNS

1 Filter device
2 Pipe section-shaped housing
2a Housing projection
3 Hollow-fibre bundle
4 Semi-permeable membrane
5 Housing interior
6 First flow space
7 Second flow space
8 Flow-space seal
9 Breaches
10 End cap
11 First opening
12 Second opening
13 First sealing area
14 Second sealing area
15 Bead
16 Hot-plate welding tool
17 Tool heating element
18 Thread
S Centre of gravity
K Contact surfaces

1. A filter device for material exchange comprising a
pipe section-shaped housing having a centre of gravity and having two housing ends, in which housing there is arranged a hollow-fibre bundle composed of semi-permeable membranes, the fibre cavities of which hollow-fibre bundle form a first flow space, and the housing interior surrounding the hollow-fibre bundle forms a second flow space,
wherein the flow spaces are separated from one another at the housing ends by at least one flow-space seal,
wherein the housing is provided with at least one breach at at least one end and the at least one breach is arranged closer to the centre of gravity of the housing than the flow-space seal,
comprising furthermore at least one end cap having a first and a second opening,
wherein the housing and the at least one end cap form a first sealing area which connects the housing and the end cap in a sealing manner and wherein the first sealing area is at a further distance from the centre of gravity of the housing than the at least one breach, and
wherein a first fluid space is formed between the first sealing area and the first opening of the end cap, via which first fluid space the first opening is fluidically connected to the first flow space,
wherein the housing and the at least one end cap form a second sealing area which connects the housing and the end cap in a sealing manner and the second sealing area is arranged closer to the centre of gravity of the housing than the flow-space seal and the at least one breach,
and wherein a second fluid space is formed between the first and second sealing area and the second opening of the end cap, via which second fluid space the second opening of the end cap is fluidically connected to the second flow space through the at least one breach,
wherein the first and second sealing area are not formed by a sealant.

2. The filter device according to claim 1, wherein in both the first and the second sealing area, molecules of the housing are entangled with molecules of the end cap.

3. The filter device according to claim 1, wherein the first sealing area is at a further distance from the centre of gravity of the housing than the at least one breach and the flow-space seal.

4. The filter device according to claim 1, wherein the pipe section-shaped housing and the end cap are formed from the same group of materials.

5. The filter device according to claim 1, wherein the material of the housing and the end cap comprises polypropylene or copolymers of polypropylene or polycarbonate.

6. The filter device according to claim 1, wherein the first sealing area is equal to or larger than the cross-sectional area of the pipe section-shaped housing at the housing end.

7. The filter device according to claim 1, wherein there are two end caps at the opposite ends of the pipe section-shaped housing and the housing is provided with breaches and flow-space seals at both ends and the breaches are in each case arranged closer to the centre of gravity of the housing than the flow-space seals.

8. The filter device according to claim 1, wherein the housing has a multiplicity of breaches at least one end.

9. The filter device according to claim 7, wherein the filter device is a dialyser and in that the first openings of the end caps allow an inflow of blood and an outflow of blood and in that the second openings of the end caps allow an inflow of dialysate and an outflow of dialysate.

10. The filter device according to claim 9, wherein the pipe section-shaped housing does not comprise a dialysate inlet or dialysate outlet.

11. The filter device according to claim 1, wherein the material of the semi-permeable membranes comprises polysulfone, polyvinylpyrrolidone, polymethyl methacrylate, polyamide, polyester, cellulose or polyacrylonitrile.

12. Method A method for producing a filter device according to claim 1, wherein the first and second sealing area are in each case produced by fusing and cooling of the regions of the housing and the end cap that face the sealing areas with formation of a sealing connection and in that entanglement of molecules of the housing with molecules of the end cap is carried out.

13. The method according to claim 12, wherein the sealing areas are in each case produced by welding.

14. A hot-plate welding tool configured for carrying out the method according to claim 12.

15. The method of claim 13, wherein the welding is hot-surface welding, laser beam welding, spin welding or ultrasonic welding.
